(19) United States
(12) Patent Application Publication
(10) Pub. No.: US 2008/0217100 A1
(43) Pub. Date: Sep. 11, 2008

(54) MOTOR VEHICLE

(76) Inventor: Norberto Mario Voltolini, Lanus (AR)

Correspondence Address: CONLEY ROSE, P.C., 5601 GRANITE PARKWAY, SUITE 750, PLANO, TX, 75024, US

(21) Appl. No.: 11/683,481

(22) Filed: Mar. 8, 2007

(51) Int. Cl. B62D 5/02

(52) U.S. Cl. 180/448

(57) ABSTRACT

A motor vehicle having two front wheels and two rear wheels, a front driver's seat and a rear passenger seat disposed behind the driver's seat, and a steering mechanism including a steering handle connected to a pair of handle rods, a steering rod and a power multiplying device connecting the handle rods to the steering rod.

### FIELD OF THE INVENTION

The present invention relates to a new vehicle of the type having two front wheels and two rear wheels and, more particularly, the invention refers to a vehicle having two seats, one seat behind the other and a handlebar, all arranged to provide the feeling and sensation of riding a motorcycle with the safety and comfort of a four wheeled vehicle, preferably a vehicle having a conventional size and weight.

For the purpose of this invention, a vehicle having a conventional size and weight should be understood as a four wheeled conventional car having two or more doors, with seats for four or more individuals and, eventually, a trunk.

### BACKGROUND OF THE INVENTION

When talking of a conventional car any people have the clear idea that they are referring to a vehicle having two front wheels and two rear wheels, a body with two or four doors, four or more seats and a steering wheel capable of rotating more than 720°, some times about 900°, necessary to move the front wheels for steering the car. The steering wheels needs to rotate along a large angle because of the big size of the vehicle and hence because of the weight thereof. The cars, except for the very smallest ones, are designed for transporting four or more passengers, including the driver, and are arranged with all the necessary components to provide comfort, stability, maneuverability and to comply with other safety requirements.

While the conventional cars have shown to be the most preferred transportation means for people, these vehicles may be uncomfortable to drive in big, huge or crowded cities. As an alternative, some people choose to ride motorcycles not only because of the smaller sizes thereof but also, and many times principally, because of the feelings and sensations derived from riding a vehicle having only two wheels, riding-type seats and a steering bar handle. Many motorcycle drivers sustain that driving this vehicle by maneuvering through a handlebar is superior as compared to drive a conventional steering wheel.

Motorcycles however, have also demonstrated that while the sensations and feelings of riding the same are not compared to conventional cars, the risk of being affected by dangerous accidents is very high as compared to four-wheeled vehicles and this is why, many people, while loving to ride a motorcycle, prefer to drive a car to get more safety conditions.

Considering the above, a goal would be to provide a new vehicle offering the same safety conditions of a conventional car but with the means to ride it and drive it as if it were a motorcycle, taking also profit of the smaller sizes of a motorcycle but conserving many comfort characteristics of a conventional automobile. One of the most important problems to get such a kind of hybrid vehicle is, at least because of the weight of the vehicle, that if one wants to steer the vehicle by a handlebar the rotation of any steering rod necessary to move the front wheels of the vehicle is, as indicated above, so extended that a handlebar should be rotated more than 360° to provide the necessary maneuverability. It is clear that a handlebar can not be rotated more than a few degrees to be a practical steering handle behaving like in a motorcycle.

US Patent Application Publication No. 2004/0079561 discloses a four wheeled vehicle including right and left front wheels, and right and left rear wheels with a steering mechanism having a bar handle. The vehicle includes a body with doors or not, a front driver's seat and a rear passenger seat disposed behind the driver's seat, with the passenger seat located between the rear wheels. While the several components are well disclosed no reference to specific or improved steering mechanisms other than the handlebar are disclosed. It is clear through the description of the US Document that it refers to a very small and light vehicle.

Considering the above it would be very convenient to have a new vehicle capable of providing all the feelings and sensations of riding a motorcycle, without the drawbacks thereof, particularly insofar as the safety is concerned, but including all the benefits and advantages of a conventional four wheeled vehicle.

### SUMMARY OF THE INVENTION

It is therefore an object of the invention to provide a new four wheeled vehicle for riding as a motorcycle, with a steering bar, a front and rear aligned seats and a steering mechanism for permitting to steer the vehicle just with the handlebar.

It is still another object of the present invention to provide a motor vehicle having two front wheels and two rear wheels, a front driver's seat and a rear passenger seat disposed behind the driver's seat, and a steering mechanism including a steering handle connected to a pair of handle rods, a steering rod and a power multiplying device connecting the handle rods to the steering rod.

It is a further object of the present invention to provide a motor vehicle having a power unit, a front axle with two front wheels, a rear axle with two rear wheels, a front driver's seat and a rear passenger seat disposed behind the driver's seat, and a steering system in the front two-wheel axle, wherein the steering system comprises: a steering handle connected to a first handle rod which in turn is connected to a second handle rod through a universal joint, a steering rod connected to the front axle, and a power multiplying device comprising a toothed bar slidably movable into the device and connected, at a first portion thereof, to a first gear mechanism of the second handle rod, and, at a second portion thereof, to a second gear mechanism of the steering rod for rotating the steering rod along a longitudinal axis thereof, the steering rod being connected to the front axle for steering the front wheels.

The above and other objects, features and advantages of this invention will be better understood when taken in connection with the accompanying drawings and description.

### BRIEF DESCRIPTION OF THE DRAWINGS

The present invention is illustrated by way of example in the following drawings wherein:

FIG. 1 shows a rear and side perspective view of the vehicle according a preferred embodiment of the invention;

FIG. 2 shows a top plant view of the vehicle of FIG. 1;

FIG. 3 shows a partial side perspective view of the vehicle of FIG. 1 with parts thereof shown in transparency to see the steering mechanism according to the invention;

FIG. 4 shows a partial top plant view of the interior of the vehicle of FIG. 1, showing the handlebar according to the invention;

FIG. 5 shows a perspective view of the steering system of the invention without the mounting cage for purposes of clarity;

FIG. 6 shows a perspective view of the steering system of FIG. 5 with the mounting cage;

FIG. 7 shows a perspective view of one of the handle rods for connecting the handlebar;

FIG. 8 shows a perspective view of the mounting cage shown in FIG. 6;

FIG. 9 shows a perspective view of a first gear mechanism;

FIG. 10 shows an exploded perspective view of the first gear mechanism of FIG. 9;

FIG. 11 shows a perspective view of rolling means for slidably mounting the toothed bar into the mounting cage;

FIG. 12 shows a perspective view of roll supporting means for mounting the first gear mechanism;

FIG. 13 shows a front perspective view of a toothed bar;

FIG. 14 shows a back perspective view of the toothed bar of FIG. 13;

FIG. 15 shows an elevation view taken from one end of the toothed bar of FIG. 13;

FIG. 16 shows a perspective view of a second gear mechanism;

FIG. 17 shows a perspective view of a steering rod;

FIG. 18 shows a diagram of the handlebar, the first gear mechanism and the toothed bar as schematically arranged in the available room into the vehicle;

FIG. 19 shows a diagram of the handlebar, the first gear mechanism and the toothed bar as schematically arranged in the available room into the vehicle, assuming that the handlebar should be enlarged to reduce the efforts to steer the vehicle, and

FIG. 20 shows a diagram of the handlebar, the first gear mechanism and the toothed bar as schematically arranged in the available room into the vehicle, with a smaller gear connected to the handle rod to reduce the efforts to steer the vehicle according to the teachings of the invention.

### DESCRIPTION OF THE PREFERRED EMBODIMENTS

Now referring in detail to the invention, the same refers to a vehicle having a general size of a conventional car but with the driving and riding fittings of a motorcycle. The vehicle, indicated by general reference number 1, comprises a body having a general view like a conventional car, preferably with two or four doors such as two front doors 2. Two rear panels 3 may be fixed panels or a couple of rear doors. The body includes a front axle with two front wheels and a rear axle with two rear wheels 5, with only the left front and rear wheels being shown.

The body may also include a rear trunk 6, rear bumpers 7 and rear lights 8. The front side of the vehicle is also provided with front bumpers 9, front lights 10 and a hood 11 under which is installed the power unit such as an internal combustion engine not shown. Like any other vehicle it also has a cockpit 12 with a front windshield 13 and, if the cockpit is open as illustrated, a safety cross bar 14 may be provided also useful for installation of a removable cover such a foldable top of a convertible. Of course, while not illustrated, the cockpit may be of the closed type with a fixed and stationary top.

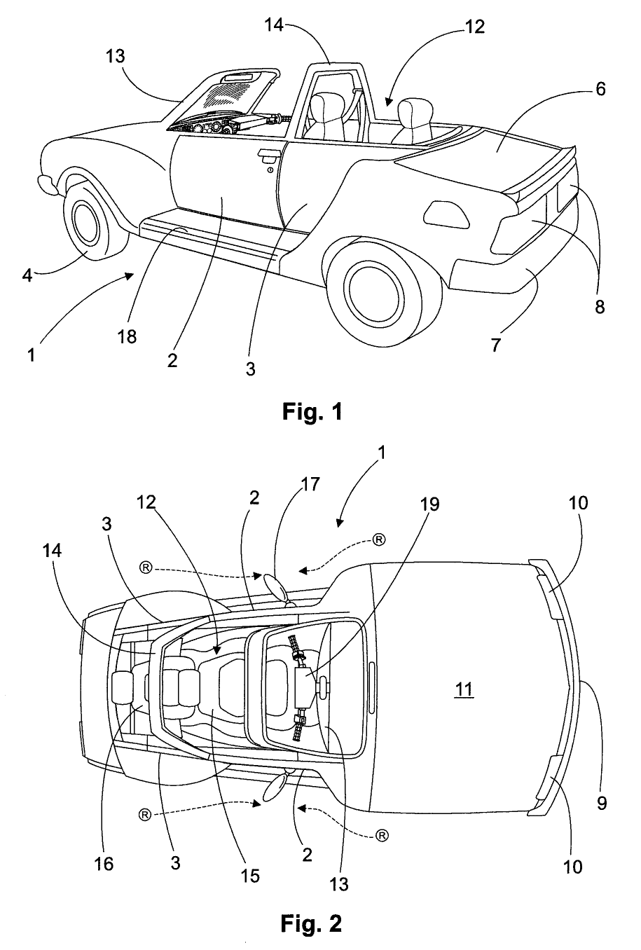

Within the cockpit, and according to one of the aspects of the invention, two seats are provided, a front driver's seat 15 and a rear passenger seat 16 disposed behind the driver's seat and aligned together. The seats may be of the type employed by motorcycles or may be like the ones of conventional automobiles with back seat and an aid for supporting the individual's head as clearly shown in FIGS. 1 and 2. Cockpit 12 also may include safety belts for the passengers, such as a cross type belt for the driver that may be easily installed in the front seat by connecting the belt to the safety cross bar 14, as shown in FIG. 1.

The inventive location of the seats, one behind the other and aligned as shown in the drawings, permits to design the outer lines of the vehicle body in a manner to form a longitudinal recess as indicated by the dotted lines “R” at the sides of the body vehicle. This leads to another advantage of the novel vehicle as it is the installation of the outer mirrors located within the outer profile of the vehicle body. This reduces the effective width of the body with the advantageous benefits in big and crowded cities. These recesses in the sides of the vehicle also permit to place respective side steps 18 very useful for elder or handicapped persons. These steps may be also designed as side bumpers or may include side bumpers for additional protections of the passengers. Additionally, the doors and side panels may include one or more inner reinforcing bars for safety purposes to act in combination with cross bar 14 to form a protection cage or structure.

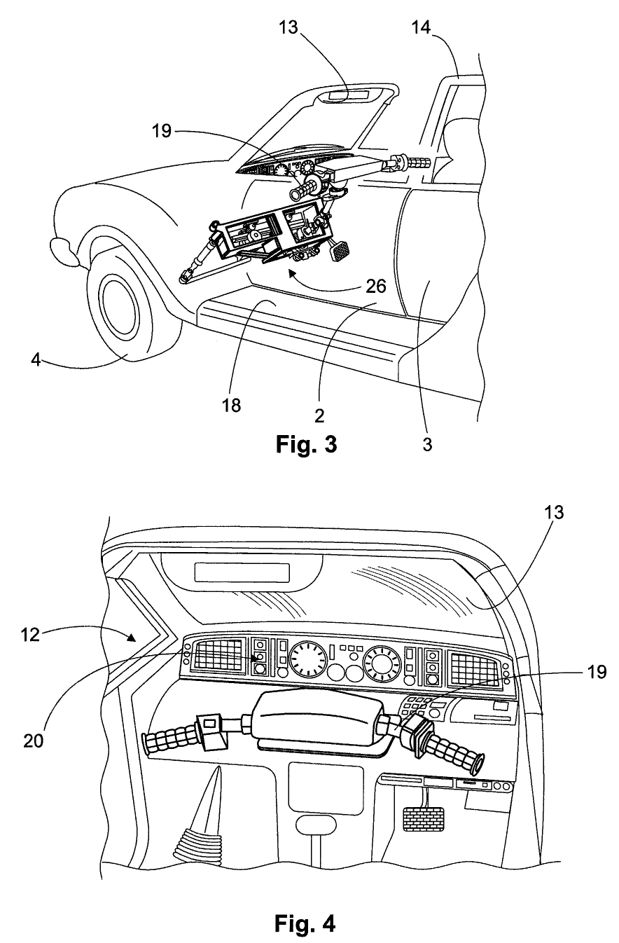

At a front location of the cockpit a steering handle, preferably a handlebar 19, and a control panel 20 are arranged according to the invention. Handlebar 19 is preferably provided with all the fittings like in a motorcycle, such as left and right handles 21, 22, accelerator 23, other controls 24 such for lights, horn, gear box, as well as an air bag 25. Handlebar 19 is part of a steering system generally indicated by reference 26 in FIGS. 3, 5, 6, for connecting to the front two-wheel axle by any mechanical or hydraulic means, even conventional hydraulic means not illustrated.

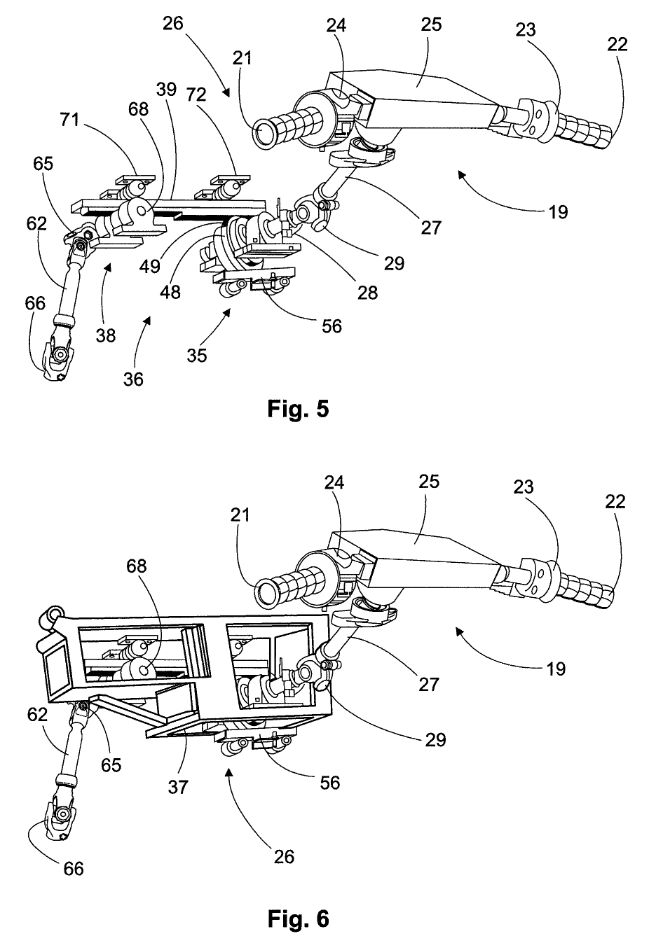

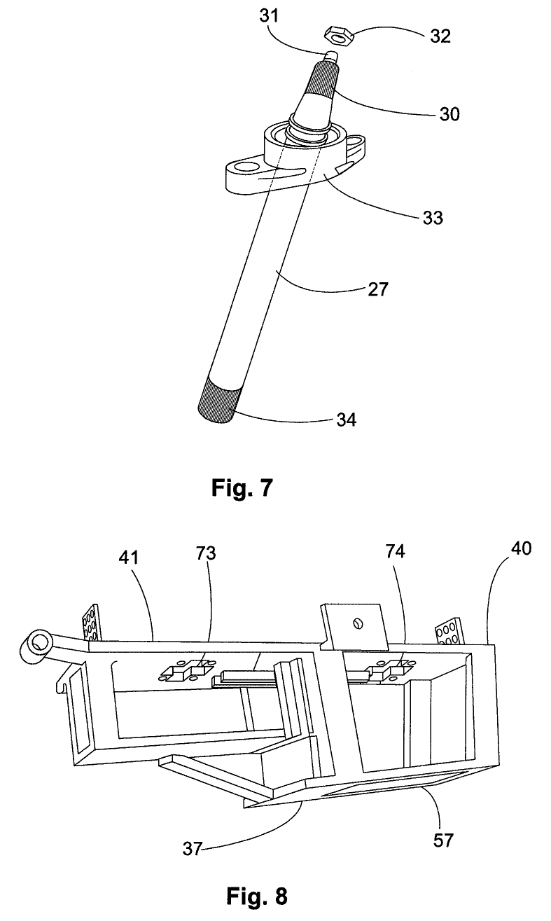

According to the teachings of the invention, steering system 26 comprises the steering handle connected to a first handle rod 27 which in turn is connected to a second handle rod 28 through a universal joint 29. Handle rod 27 has a an upper conical and notched end 30 with a threaded pin 31 and nut 32 to firmly fix the handle bar. Rod 28 is mounted in any firm part of the vehicle by means of bushing and/or rolling means 33 and a distal or lower end 34 of the rod is also designed, for example by coupling notches, to be connected to universal joint 29. Second handle rod 28 is connected to joint 29 and to a first gear mechanism, generally indicated by reference 35, that forms part of a power multiplying device 36 housed and mounted into a mounting cage 37. Cage 37 also houses and mounts a second gear mechanism 38 that is connected in transmission relationship to first gear mechanism 35 by means of a toothed bar 39 slidably mounted in cage 37. FIG. 5 shows these mechanisms with the mounting cage being removed for clarity purposes but FIG. 6 shows the mechanisms and cage 37 to see how the components are housed therein.

Mounting cage 37, forming part of power multiplying device 36, may be made of any suitable material and comprises a first cage section 40 for receiving first gear mechanism 35 and a second cage section 41 for receiving second gear mechanism 38. Toothed bar 39 slidably movably extends across of both first 40 and second 41 cage sections and has a first portion 42 engaged with first gear mechanism 35, and a second portion 43 engaged with second gear mechanism 38. Thus, first portion 42 of the toothed bar will be located into first cage section 40 and second portion 43 of the toothed bar will be located into second cage section 41. Sections 42 and 43 will be preferably stepped, that is a different level as well as section 42 is provided with straight teeth to engage first mechanism 35 and section 43 will have helical teeth to engage second mechanism 38.

First gear mechanism 35 comprises a pinion gear 44 in a distal end of second handle rod 28, opposite to a proximal end connected to joint 29. Pinion gear is mounted within a ring gear 45 and pinion 44 has a toothed periphery 46 engaged or coupled to an inner toothed periphery 47 of ring gear 45. Periphery 47 is preferably completely toothed but it would be also partially toothed just in the portion of the periphery that is engaged with pinion 44. Ring gear 45 also has an outer periphery 48 that is at least partially toothed in 49, in an arc extending along at least 90° and preferably along only 90°. Toothed sector 49 is in gearing engagement with first portion 42 of toothed bar 39 and ring gear 45 is rotatably freely mounted into the first cage section.

Pinion gear 44 and ring gear 45 are engaged and sandwiched between two cap plates, a first cap plate 50 fixed to second handle rod 28, and a second cap plate 51 fixed to the first cap plate and to the pinion gear by a plurality of bolts 52 passing through aligned orifices in the cap plates and the pinion gear and fixed by corresponding nuts 53. This assembly is rotatably mounted through second handle rod 28 that passes through corresponding bushings 54, 55, with one bushing at each side of the sandwiched pinion and ring gears, in the first section of the cage. Also, periphery 48, that is free of teeth is arranged to roll over roll supporting means 56 mounted in a connection cut 57 in a bottom of the first section of mounting cage 37, FIG. 8. Roll supporting means 56 is comprised of a couple of bars 58, 59, supporting a couple of rolls 60, 61, in a manner that periphery 48 rests and rolls over both rolls 60, 61. Therefore, when moving handle bar 19, rods 27, 28 are rotated in order to rotate pinion 44 and ring gear 45 in an easy, light manner and along a short angle, preferably 90° to move toothed bar or rack 39 left and right.

Toothed bar 39 is connected to a steering rod 62 having a proximal end 63 and a distal end 64 having corresponding universal joints 65, 66, with joint 65 being designed to be connected to the front axle of the vehicle by means of any mechanical or hydraulic system. Steering rod 62 receives rotary motion from second gear mechanism 38 in a manner that rod 62 may rotate along a longitudinal axis thereof.

Second gear mechanism comprises a worm gear 67 mounted in a pair of bushings 68, 69 in the second section of the cage and engaged to the second portion 43 of the toothed bar. Worm gear 67 is connected, preferably at end 80 thereof, to proximal end 63 of the steering rod by means of universal joint 65, wherein any rotation of worm gear 67 is transmitted to steering rod 62.

While teeth of portions 42, 43 at a front side of toothed bar 39 remains engaged with ring gear 45 and worm gear 67, a back side 70 of bar 39 is slidably mounted onto rolling means 71, 72 fixed in the first and second sections of the cage, particularly in mounting cuts 73, 74, FIG. 8. One 71 of the rolling means is shown in FIG. 12, comprising a pair of parallel bar 75, 76 and at least one roll 77. Back side 70 of bar 39 will rest against rolls 77 to move left and right within cage 37 as shown in FIGS. 5 and 6. Bars 75, 76 will be provided with orifices 78, 79 for installing rolling means 71 into cage 37 and in a manner that rolling means may be regulated to adjust the position of bar 39.

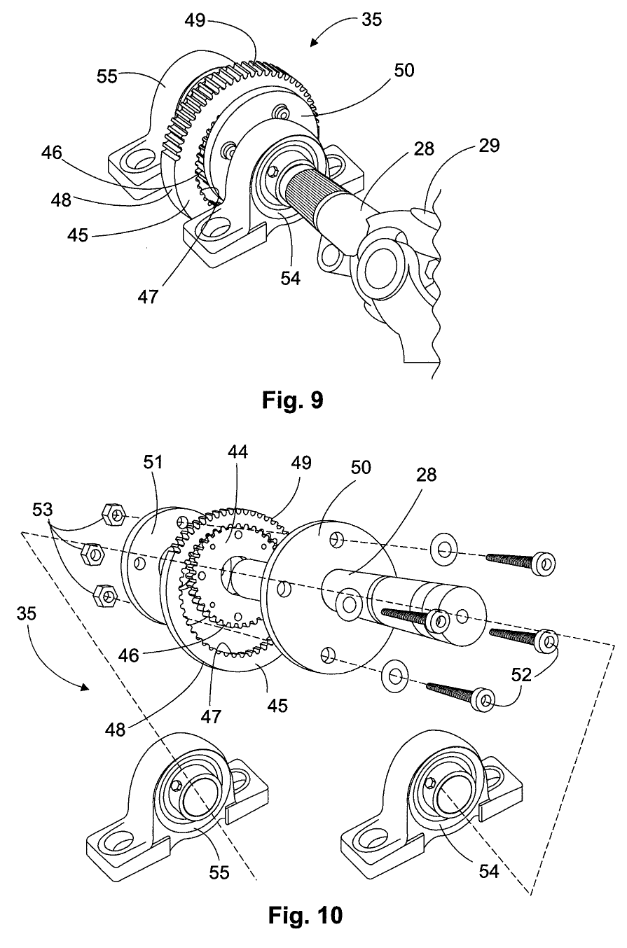

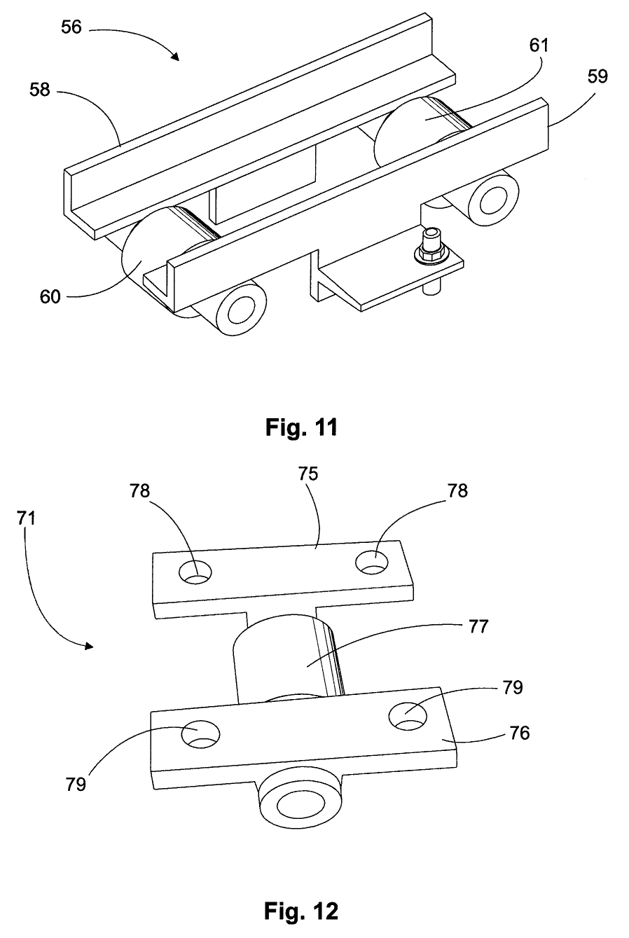

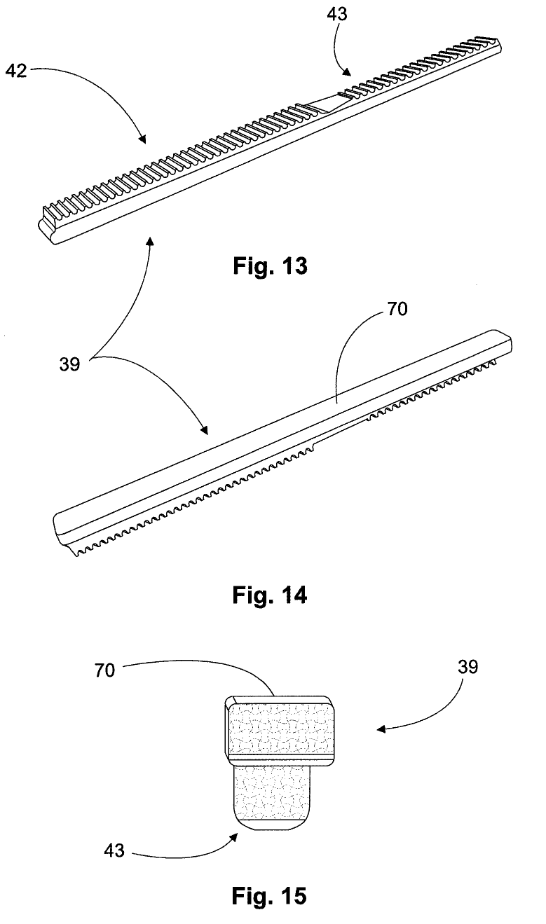

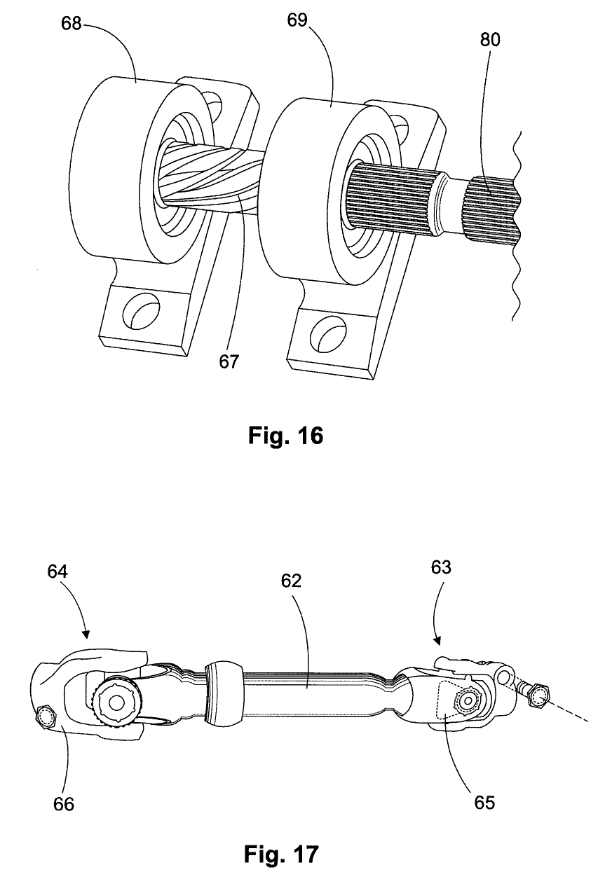

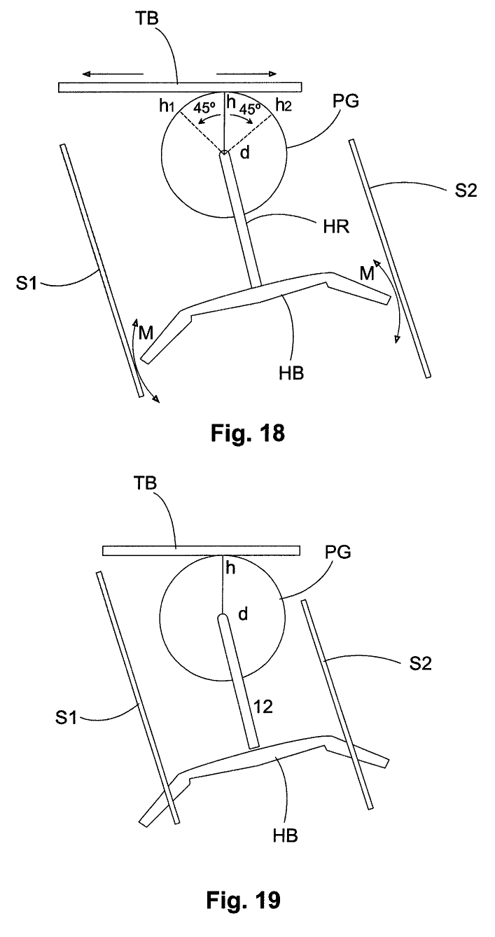

FIGS. 18-20 illustrate the concept of combining a pinion gear 44 with a ring gear 45 in a manner that pinion 44 is installed inside ring 45 and offset relative the longitudinal axis of ring gear 45 as shown in FIG. 9, 10. FIG. 18 schematically shows the situation of a handle bar HB connected to a handle rod HR which has a distal end thereof a pinion gear PG engaged with a toothed bar TB. The segment d-h indicates the radius or distance between the center of pinion PG and the point where the peripheral tooth or teeth of the pinion is effectively engaged with the tooth or teeth of bar TB.

Considering that a handle bar is employed it would be necessary that the same does not need to rotate more than about 90°, namely along the arc h1-h2 to move bar TP left and right enough to move the wheels of the vehicle during steering. However, the force necessary to move the wheels of a vehicle like the one of the invention is very high in such an extent that the extension of the handle bar is insufficient as illustrated in FIG. 18. Lines S1 and S2 indicates the sides of the vehicle and hence the available room for the extension of the handle bar.

A solution to reduce the force necessary to steer the vehicle may be to arrange a larger handle bar, as shown in FIG. 19, however the available room, as indicated above, is restricted by the sides S1 and S2 of the vehicle, therefore a larger handle bar can not be installed.

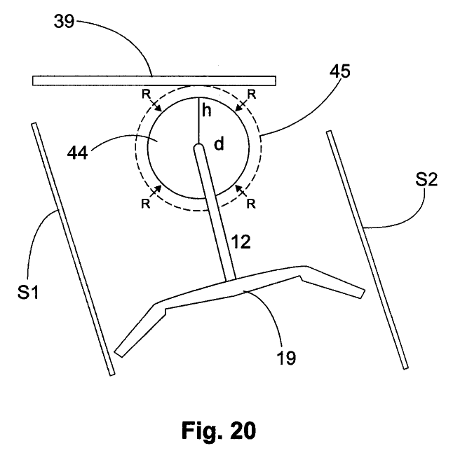

Under the above circumstances the solution provided by the invention comprises the combination of ring gear 45 having its toothed periphery engaged with toothed bar 39 and pinion gear 44 having toothed periphery 46 engaged with inner toothed periphery 47 of ring gear 45. The small radius of pinion 44 and the arrangement of the pinion offset of the longitudinal axis of ring gear 45 provides an important reduction in the force necessary to steer the wheels of the vehicles and permits to have the necessary steering by rotating handle bar 19 just along about 90°. FIG. 20 shows a scheme of this arrangement wherein arrows R indicate the reduction of pinion gear PG of FIGS. 18, 19 and the replacement by ring gear 45, with the radius d-h of pinion 44 being shorter than the one shown in FIGS. 18, 19. Thus, handle bar of the present invention may have a short extension and the necessary rotation thereof is only along a short angle.

While preferred embodiments of the present invention have been illustrated and described, it will be obvious to those skilled in the art that various changes and modifications may be made therein without departing from the scope of the invention as defined in the appended claims.

What is claimed is:

1. A motor vehicle having:
a power unit,
a front axle with two front wheels,
a rear axle with two rear wheels,
a front driver's seat and a rear passenger seat disposed behind the driver's seat, and
a steering system in the front two-wheel axle, wherein the steering system comprises:
a steering handle connected to a first handle rod which in turn is connected to a second handle rod through a universal joint,
a steering rod connected to the front axle, and
a power multiplying device comprising a toothed bar slidably movable into the device and connected, at a first portion thereof, to a first gear mechanism of the second handle rod, and, at a second portion thereof, to a second gear mechanism of the steering rod for rotating the steering rod along a longitudinal axis thereof, the steering rod being connected to the front axle for steering the front wheels.

2. The motor vehicle of claim 1, wherein the steering handle is a steering bar.

3. The motor vehicle of claim 1, wherein the power multiplying device comprises a mounting cage having a first cage section for receiving said first gear mechanism and a second cage section for receiving said second gear mechanism, with the toothed bar extending across of both the first and second cage sections and with the first portion of the toothed bar located into said first cage section and the second portion of the toothed bar located into said second cage section.

4. The motor vehicle of claim 3, wherein the second handle rod has a distal end and a proximal end and the first gear mechanism comprises a pinion gear mounted in the distal end of the second handle rod, with the proximal end of the second handle rod being having said universal joint for connecting the first handle rod.

5. The motor vehicle of claim 4, wherein the pinion gear has a toothed periphery engaged to an inner toothed periphery of a ring gear, the ring gear having an outer periphery at least partially toothed and engaged to the first portion of the toothed bar, the ring gear being rotatably freely mounted in the first cage section.

6. The motor vehicle of claim 5, wherein the pinion gear and the ring gear are engaged and sandwiched between two cap plates, a first cap plate fixed to the second handle rod, and a second cap plate fixed to the first cap plate and to the pinion gear by a plurality of bolts passing through the cap plates and the pinion gear.

7. The motor vehicle of claim 6, wherein the second handle rod is rotatably mounted in a couple of bushings, one bushing at each side of the sandwiched pinion and ring gears, in the first section of the cage.

8. The motor vehicle of claim 6, wherein the at least partially toothed outer periphery of the ring gear has a portion thereof free of teeth to roll over roll supporting means mounted in the mounting cage.

9. The motor vehicle of claim 8, wherein the second gear mechanism comprises a worm gear mounted in a pair of bushings in the second section of the cage and engaged to the second portion of the toothed bar, wherein the worm gear is connected to a proximal end of the steering rod by means of a universal joint, with the steering rod having a distal end for connection to the front axle.

10. The motor vehicle of claim 9, wherein the toothed bar has a back side and a front side, the front side including a plurality of gearing teeth engaged to the first and second gear mechanism and the back side being slidably mounted onto rolling means fixed in the first and second sections of the cage.

11. The motor vehicle of claim 10, wherein the first and second portions of the toothed bar are stepped portions.
